(19) United States
(12) Patent Application Publication
(10) Pub. No.: US 2011/0016946 A1
(43) Pub. Date: Jan. 27, 2011

(54) Coated Tooling

(76) Inventors: Sudhir Brahmandam, Irwin, PA (US); David R. Siddle, Greensburg, PA (US); Peter R. Leicht, Latrobe, PA (US); Irene Spitsberg, Export, PA (US)

Correspondence Address: KENNAMETAL INC.;Intellectual Property Department, P.O. BOX 231, 1600 TECHNOLOGY WAY, LATROBE, PA, 15650, US

(21) Appl. No.: 12/506,782

(22) Filed: Jul. 21, 2009

(51) Int. Cl. B21D 37/01; B32B 7/02; B05D 1/36; B32B 9/00

(52) U.S. Cl. 72/462; 428/216; 427/402; 427/404; 427/419.2; 427/419.7

(57) ABSTRACT

A coated forming tool including a tool component and a wear resistant coating on at least a portion of the tool component. The wear resistant coating includes a bottom coating layer and a top coating layer. The top coating layer has a thickness from about 1 μm to about 12 μm and the coating has a thickness ratio of the bottom coating layer thickness to the top coating layer thickness from about 0.5 to about 5.

### FIELD OF THE INVENTION

The invention is directed to a wear resistant coating and more particularly, is directed to a wear resistant coating for forming tools used in warm and hot metal forming applications.

### BACKGROUND INFORMATION

Metal forming is a frequently used operation for shaping work pieces into either a final shape, near net shape or a net shape that is further machined to a desired final shape. Metal forming tools are commonly made of steels, super alloys, carbides, and ceramics. The working conditions of these tools in metal forming applications are challenging as they are subjected to impact loads, high contact loads, severe wear as well as thermo-mechanical cycling and oxidative conditions. An example of a critical failure mode of these tools is surface wear due to low wear resistance of the tool surface. Additional examples of failure include surface degradation due to interactions between the tool and the work piece, corrosive lubricants, or the environment, as well as temperature and thermo-mechanical loading, which in turn leads to mechanical damage such as surface pitting or cracking of the tool surface.

One way to address at least some of these failure modes is through the use of coatings. Coatings are often used to extend the life of tooling by increasing wear resistance and minimizing surface degradation. These coatings however perform well in cold forming conditions but tend to yield poor performance under warm and hot forming operations or under high contact loading conditions. The low performance of the coatings in these situations can be attributed to the inability of the coating to withstand cyclic thermo-mechanical or high contact loading applications faced for example, in warm and hot forming applications.

In warm and hot metal forming processes, the tooling is exposed to thermo-mechanical conditions and therefore experiences a high thermal gradient through the thickness of the tool for example. In addition, the surface of the tooling is also subjected to cyclic thermal loading and compressive—tensile stress cycles. The thermo-mechanical load cycle of tooling in warm and hot forming operations is also significantly different than that of tooling in cold forming operations. The thermal loading in warm and hot forming operations contributes significantly to the overall stress state, as well as creates transient stress upon reversal of the thermal cycle. Therefore coatings that may perform well under cold forming conditions typically do not provide the same performance or desired properties in high temperature forming applications.

Additionally, studies performed suggest that another factor in coating performance is the thickness of the coating. For example, thicker coatings may help in preventing failure due to wear and oxidation of the tool-surface. However, at the same time, thicker coatings may also result in premature failure due to poor load bearing capability and lower resistance to thermo-mechanical cycling. One scheme of addressing this constraint is through the introduction of thin soft metal layer(s) interspersed with the harder, more wear resistant layers in the coating, which can greatly improve the overall ductility of the coating system. However, this solution reduces the peak load bearing capability as well as lowers the maximum operating temperature of the coating and therefore, is not a solution for warm and hot metal fowling applications.

Accordingly, there is a need for a coating that provides improved wear life as well as oxidation resistance properties for forming tools used in thermo-mechanical load applications.

### SUMMARY OF THE INVENTION

The invention provides a coated forming tool. The coated forming tool includes a tool component and a wear resistant coating on at least a portion of the tool component. The wear resistant coating includes a bottom coating layer and a top coating layer. In one embodiment, the top coating layer has a thickness from about 1 to about 12 μm and the coating has a thickness ratio of the bottom coating layer thickness to the top coating layer thickness (T_{B}:T_{T}) from about 0.5 to about 5. For example, the top coating layer may have a thickness from about 4 μm to about 10 μm, such as from about 4 μm to about 8 μm. The coating may have a thickness ratio from about 0.7 to about 3. The top coating layer may include alumina or aluminum-containing phases. The bottom coating layer may include TiCₓN₍₁₋ₓ₎ or TiMCₓN₍₁₋ₓ₎, where x is in the range of 0 to 1 in an atomic ratio and M is aluminum or a transition element from Groups 4, 5, and 6 of the periodic table. The coating may include at least one additional coating layer provided as a protective layer over the top coating layer, an intermediate layer between the top coating layer and the bottom coating layer, a bonding layer between the bottom coating layer and the tool component, or any and all combinations thereof. The coated forming tool may be used in warm or hot forming applications. The tool component may be selected from the group consisting of punches, dies, and components used in applications that experience thermo-mechanical loading.

Another aspect of the invention provides a coating for use on forming tools. The coating includes a top coating layer having a thickness from about 1 μm to about 12 μm and a bottom coating layer. The coating has a thickness ratio of the bottom coating layer to the top coating layer (T_{B}:T_{T}) from about 0.5 to about 5. Preferably, the top coating layer has a thickness from about 4 μm to about 10 μm, such as from about 4 μm to about 8 μm. The coating has a thickness ratio from about 0.7 to about 3. The top coating layer includes alumina or aluminum-containing phases. The bottom coating layer may include TiCₓN₍₁₋ₓ₎ or TiMCₓN₍₁₋ₓ₎, where x is in the range of 0 to 1 in an atomic ratio and M is aluminum or a transition element from Groups 4, 5, and 6 of the periodic table. The coating may include at least one additional coating layer provided as a protective layer over the top coating layer, an intermediate layer between the top coating layer and the bottom coating layer, a bonding layer between the bottom coating layer and the forming tool, or any and all combinations thereof.

Another aspect of the invention is a method of coating a forming tool for use in thermo-mechanical loading applications. The method includes applying a coating on at least a portion of a forming tool. The coating includes a bottom coating layer and a top coating layer. The top coating layer has a thickness from about 1 μm to about 12 μm and the coating has a thickness ratio of the bottom coating layer to the top coating layer (T_{B}:T_{T}) from about 0.5 to about 5. The top coating layer has a thickness from about 4 μm to about 10 μm, such as from about 4 μm to about 8 μm. The coating has a thickness ratio from about 0.7 to about 3. The top coating layer may include alumina or aluminum-containing phases. The bottom coating layer may include TiCₓN₁₋ₓ₎ or TiMCₓN₍₁₋ₓ₎, where x is in the range of 0 to 1 in an atomic ratio and M is aluminum or a transition element from Groups 4, 5, and 6 of the periodic table. The coating may include at least one additional coating layer provided as a protective layer over the top coating layer, an intermediate layer between the top coating layer and the bottom coating layer, a bonding layer between the bottom coating layer and the forming tool, or any and all combinations thereof.

These and other aspects of the present invention will be more fully understood following a review of this specification and drawing.

### BRIEF DESCRIPTION OF THE DRAWINGS

FIG. 1 illustrates a cross-sectional view of a coated forming tool in accordance with an embodiment of the invention.

### DETAILED DESCRIPTION OF PREFERRED EMBODIMENT

Before the present methods and materials are described, it is to be understood that this disclosure is not limited to the particular methodologies and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art. As used herein, the term “about” means plus or minus 10% of the numerical value of the number with which it is being used. Therefore, about 50% means in the range of 45%-55%.

As used herein, the term ‘forming tool’ generally refers to any component used in thermo-mechanical loading applications including for example, metal forming tools used in warm or hot forming applications. Warm forming applications typically are applications at temperatures above 200° C., such as 400° C. to 900° C. Hot forming applications are typically applications above 900° C., such as 900° C. to 1300° C.

As used herein, the term ‘Groups 4, 5, and 6’ in reference to the periodic table refers to the current IUPAC scheme for Groups or Columns on the periodic table.

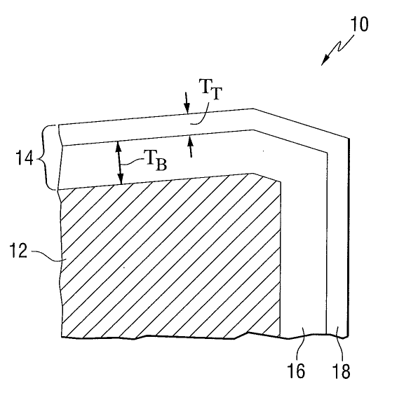

One embodiment of the invention is generally directed to a coating for forming tools used in warm or hot metal forming applications or any thermo-mechanical load applications. FIG. 1 illustrates a cross section piece of a coated forming tool 10 according to the invention. Coated forming tool 10 includes a tool component 12 and a coating 14 on at least a portion thereon. Coating 14 includes a base or bottom coating layer 16, having a thickness T_{B}, and a top coating layer 18, having a thickness T_{T}. The top coating layer 18 is located on a top side of the bottom coating layer 16.

The composition of the top coating layer may be selected based on the desired application, environment and/or working conditions of the tool or component. The top coating layer preferably exhibits superior wear resistance, inertness to the working environment, such as intimate contact with a metal billet at high temperature, and handles cyclic contact loading. In certain embodiments, the top coating layer may have a composition of oxides, such as alumina and zirconia oxides, or may be nitrides, carb-oxy-nitrides and the like. In other embodiments, the top coating layer may be alumina or an aluminum containing phase such as Al—Cr—O—N or Ti—Al—Cr—O—N. In yet other embodiments, the top layer may be a-alumina. The top coating layer has a thickness range from about 1 μm to 12 μm, such as about 4 μm to about 10 μm. In other embodiments the top coating layer may have a thickness range from about 4 μm to about 8 μm.

The bottom coating layer may have a composition of TiCₓN₍₁₋ₓ₎, where x varies from 0-1 atomic fraction. In embodiments, the bottom coating layer may have a composition of TiMCₓN₍₁₋ₓ₎ where M is aluminum or a transition element from Groups 4, 5, and 6 of the periodic table and x varies from 0-1 atomic fraction. Examples of suitable transition metals, M, include but is not limited to zirconium, hafnium, vanadium, tantalum, chromium and manganese.

The thickness T_{B} of the bottom coating layer 16 is selected such that a ratio of thickness T_{B} of the bottom coating layer 16 to the thickness T_{T} of the top coating layer (the “T_{B}:T_{T}”) is in the range from about 0.5 to about 5, such as from about 0.7 to about 3. It has been found that this thickness ratio is critical to the invention as the inventors have unexpectedly learned that controlling the thickness of the top coating layer and the thickness ratio of the coating significantly improves at least the tool life of forming tools used in warm and hot forming applications by delaying, for example, failure from oxidation, wear, contact fatigue or cyclic thermal fatigue. The bottom coating layer acts to accommodate thermal mismatch strains between the top coating layer and the tool component, and for example, provides sufficient mechanical support to handle the stresses resulting from contact loads, for example, between the forming tool and the work piece, and sliding loads.

It should be noted that it is further based on a counter intuitive finding that a ceramic coating can be designed in such a way that the combination of a suitably bottom thick ceramic bottom layer with a ceramic top layer achieves the required improvement in wear life/oxidation resistance while withstanding peak contact loads and thermo-mechanical cycles. For example, while not being bound to a specific theory, a coating having a top coating layer and a thickness ratio greater than that described herein would fail due to thermal fatigue and a top coating layer thickness and a thickness ratio less than that described herein would exhibit poor wear resistance and oxidation resistance and/or contact fracture, for example, the inability to withstand the contact load between the tool and the work piece.

Suitable materials for the forming tool or component include, but are not limited to, cemented carbides (for example, tungsten carbide-cobalt materials), ceramics (for example, silicon nitride-based ceramics, SiAION-based ceramics, titanium carbonitride-based ceramics, titanium diboride-based ceramics, and alumina-based ceramics), cermets (for example, cermets that have nickel-cobalt binder and a high level of titanium and could further include tungsten carbide and titanium carbide), superalloys, and steels.

In embodiments, the coating may include at least one additional layer. The at least one additional layer may be provided as a protective layer over the top coating layer, as an intermediate layer between the top coating layer and the bottom coating layer, as a bonding layer between the bottom coating layer and the forming tool, or as any or all combinations thereof, including all three additional layers. In one embodiment, the at least one additional layer may be thin and have a composition of Ti(C,N). The at least one additional layer may be used to enhance adhesion or bonding or for example allow the microstructure of the coating to be controlled. The at least one additional layer of the coating aids in preventing diffusion of reactive species to the component and assists in handling the stress state without spalling or cracking.

In certain embodiments, the at least one additional layer may be located on a top side of the top coating layer. This additional layer may be for wear indicating purposes (such as golden colored TiN) or alternatively may be used to provide lubricity.

The coating may be applied to at least a portion of the tool or component or in embodiments may be applied to the entire external surface of the coating. The coating may be applied to the component or forming tool by a range of coating technologies, including but not limited to physical vapor deposition or chemical vapor deposition. After applying the coating on the substrate or forming tool, additional post coat treatments can occur to enhance the coating performance, for example, by introducing additional compressive stress in the coating. Examples of post coat treatments include but are not limited to blasting, chemical polishing, mechanical polishing, and the like.

The coating of the invention may be used with any component in any thermo-mechanical load applications, including warm or hot forming tool applications. Examples of metal forming tools includes, but are not limited to punches and dies. Examples of thermo-mechanical load applications include but are not limited to molten metal handling systems, molten glass handling systems, automotive engines, as well as single components such as compressor blades and turbine shafts. The coated component of the invention provides wear resistance in situations where the coated component typically comes in contact with work pieces having a temperature of about 400° C. to 1250° C. as well as loads of up to about 10 GPa.

The following examples are intended to illustrate the invention and should not be construed as limiting the invention in any way.

### Example 1

Pursuant to the invention, tool-life of four coated carbide punches having a coating according to one embodiment was tested. Each carbide punch was coated with a bottom coating layer of TiCN and a top coating layer of alumina. The thickness of the top coating layer was 5 μm, the thickness of the bottom coating layer was 5 μm, and the thickness ratio (ratio of bottom coating layer thickness to the top coating layer thickness) was 1. In use, the coated carbide punches were in contact with work pieces having a temperature of about 700° C. The tool life was measured by the number of punches that occurred before failure. Failure occurred when the work piece no longer met the required specifications (for example, inner diameter and outer diameter measurements) as well as a visual inspection of the produced workpiece. Table 1 below shows the number of punches performed by each coated carbide (punch) before failure occurred.

TABLE 1

| Sample | No. of Punches |
|---|---|
| A | 65,000 |
| B | 70,000 |
| C | 85,000 |
| D | 87,000 |

### Example 2

Six carbide punches were coated with a different coating according to one embodiment of the invention. The coating had a top coating layer of alumina and a bottom coating layer of TiCN. The thickness of the top layer was 5 μm, the thickness of the bottom layer was 10 μM, and the thickness ratio was 2. Tool life of the punches was measured as described in Example 1. The temperature of the work piece that the coated carbide punch was in contact with was about 700° C. Table 2 shows the number of punches performed by each coated carbide punch before failure occurred. Note that similar components with a commercially available coating of alumina-zirconia have an average tool life of 35,000 punches. Accordingly the coating of the invention provides wear resistance of at least 2 to 4 times greater than that of commercially available coatings.

TABLE 2

| Sample | No. of Punches |
|---|---|
| A | 95,000 |
| B | 102,000 |
| C | 105,000 |
| D | 130,000 |
| E | 138,000 |
| F | 152,000 |

Whereas particular embodiments of this invention have been described above for purposes of illustration, it will be evident to those skilled in the art that numerous variations of the details of the present invention may be made without departing from the invention as defined in the appended claims.

What is claimed is:

1. A coated forming tool, comprising:
a tool component; and
a wear resistant coating on at least a portion of the tool component, wherein the wear resistant coating comprises a bottom coating layer and a top coating layer, said top coating layer having a thickness from about 1 μM to about 12 μm and said coating having a thickness ratio of the bottom coating layer to the top coating layer from about 0.5 to about 5.

2. The coated forming tool according to claim 1, wherein the top coating layer has a thickness from about 4 μm to about 10 μm.

3. The coated forming tool according to claim 1, wherein the coating has a thickness ratio from about 0.7 to about 3.

4. The coated forming tool according to claim 1, wherein the top coating layer comprises alumina or aluminum-containing phases.

5. The coated forming tool according to claim 1, wherein the bottom coating layer comprises TiCₓN₍₁₋ₓ₎ or TiMCₓN₍₁₋ₓ₎, where x is in the range of 0 to 1 in an atomic ratio and M is aluminum or a transition element from Groups 4, 5, and 6 of the periodic table.

6. The coated forming tool according to claim 1, wherein the coating comprises at least one additional coating layer located on at least an exterior of the top coating layer, between the top coating layer and the bottom coating layer, between the bottom coating layer and the tool component, or any combination thereof.

7. The coated forming tool according to claim 1, wherein the forming tool is used in warm or hot forming applications.

8. The coated forming tool according to claim 1, wherein the tool component is selected from the group consisting of punches, dies, and components used in thermo-mechanical load applications.

9. A coating for use on a forming tool, comprising:
a top coating layer having a thickness from about 1 μm to about 12 μm; and
a bottom coating layer, wherein the coating has a thickness ratio of the bottom coating layer to the top coating layer from about 0.5 to about 5.

10. The coating according to claim 9, wherein the top coating layer has a thickness from about 4 μm to about 10 μm.

11. The coating according to claim 9, wherein the coating has a thickness ratio from about 0.7 to 3.

12. The coating according to claim 9, wherein the top coating layer comprises alumina or aluminum-containing phases.

13. The coating according to claim 9, wherein the bottom coating layer comprises TiCₓN₍₁₋ₓ₎ or TiMCₓN₍₁₋ₓ₎, where x is in the range of 0 to 1 in an atomic ratio and M is aluminum or a transition element from Groups 4, 5, and 6 of the periodic table.

14. The coating according to claim 9, wherein the coating comprises at least one additional coating layer located on at least an exterior of the top coating layer, between the top coating layer and the bottom coating layer, between the bottom coating layer and the forming tool, or any combination thereof.

15. A method of coating a forming tool for use in thermo-mechanical loading applications, comprising:
applying a coating on at least a portion of a forming tool, wherein the coating comprises a bottom coating layer and a top coating layer, wherein the top coating layer has a thickness from about 1 μm to about 12 μm and the coating has a thickness ratio of the bottom coating layer to the top coating layer from about 0.5 to about 5.

16. The method according to claim 15, wherein the top coating layer has a thickness from about 4 μm to about 10 μm.

17. The method according to claim 15, wherein the coating has a thickness ratio from about 0.7 to about 3.

18. The method according to claim 15, wherein the top coating layer comprises alumina or aluminum-containing phases.

19. The method according to claim 15, wherein the bottom coating layer comprises TiCₓN₍₁₋ₓ₎ or TiMCₓN₍₁₋ₓ₎, where x is in the range of 0 to 1 in an atomic ratio and M is aluminum or a transition element from Groups 4, 5, and 6 of the periodic table.

20. The method according to claim 15, wherein the coating comprises at least one additional coating layer located on at least an exterior of the top coating layer, between the top coating layer and the bottom coating layer, between the bottom coating layer and the forming tool, or any combination thereof.
